(19) United States
(12) Patent Application Publication
(10) Pub. No.: US 2015/0194727 A1
(43) Pub. Date: Jul. 9, 2015

(54) ANTENNA CONNECTION STRUCTURE

(71) Applicant: GRAND-TEK TECHNOLOGY CO., LTD., New Taipei City (TW)

(72) Inventor: Han-Hsuan YU, New Taipei City (TW)

(21) Appl. No.: 14/552,492

(22) Filed: Nov. 25, 2014

(30) Foreign Application Priority Data
Jan. 3, 2014 (TW) 103200080

(51) Int. Cl. H01Q 1/50

(52) U.S. Cl. CPC H01Q 1/50

(57) ABSTRACT

An antenna connection structure includes a substrate, an electrical connector and a panel antenna. The electrical connector includes a hollow cylinder and a wire. Two ends of the hollow cylinder are a top end and a bottom end respectively. The bottom end is connected to the substrate. A terminal is disposed on the top end and is arranged along the axial direction of the hollow cylinder. An end portion of the wire goes through the hollow cylinder via the lateral side thereof and is electrically connected to the terminal. The panel antenna is with a hole formed thereon. The hollow cylinder supports and is between the panel antenna and the substrate so the panel antenna and the substrate are separated from each other and parallel to each other. The terminal is plugged into the hole. The electrical connector electrically connect and supports the panel antenna and the substrate.

### TECHNICAL FIELD

The disclosure relates to an antenna connection structure, more particularly to a panel antenna connection structure whose structure is simple.

### BACKGROUND

A panel antenna is a common electronic component used for communication. It is usually disposed on a substrate and is electrically connected thereto. This enables the substrate to transmit and receive signals via the panel antenna.

Generally speaking, the panel antenna and the substrate are parallel placed. Multiple supporting sticks are disposed between the panel antenna and the substrate to support them. The panel antenna and the substrate are electrically connected by a wire and two ends of the wire are welded on and are electrically connected to the panel antennal and the substrate respectively. Since this requires supporting sticks and the wire for connecting the panel antenna and the substrate together, the structure is therefore complicated and hard to be processed and assembled.

The goal of the disclosure is to provide an improved antenna connection structure capable of solving problems mentioned above.

### SUMMARY

To reach the goal, the disclosure provides an antenna connection structure whose structure is simple.

An antenna connection structure comprises a substrate, an electrical connector and a panel antenna. The electrical connector comprises a hollow cylinder and a wire. Two ends of the hollow cylinder are a top end and a bottom end respectively. The bottom end is connected to the substrate. A terminal is disposed on the top end and is arranged along the axial direction of the hollow cylinder. An end portion of the wire goes through the hollow cylinder via the lateral side thereof and is electrically connected to the terminal. The panel antenna is with a hole formed thereon. The hollow cylinder supports and is between the panel antenna and the substrate so that the panel antenna and the substrate are separated from each other and are parallel to each other. The terminal is plugged into the hole.

In one embodiment, the lateral side of the hollow cylinder extends and forms a wiring tube connecting the hollow cylinder, and the wire penetrates the hollow cylinder through the wiring tube.

In one embodiment, the antenna connection structure further comprises an insulating sleeve sleeved on the end portion of the wire and goes through the wiring tube

In one embodiment, the top end of the hollow cylinder has an opening connecting an inner space of the hollow cylinder, and the terminal is disposed on and penetrates an insulating block disposed in the opening.

In one embodiment, the bottom end of the hollow cylinder has a connection port. A protruding block is disposed on a surface of the substrate while the connection port is sleeved on the protruding block.

In one embodiment, the connection port connects an inner space of the hollow cylinder.

In one embodiment, another end portion of the wire is connected to the substrate.

In one embodiment, a circuit is disposed on the substrate while another end portion of the wire is connected to the substrate and is electrically connected to the circuit.

In the antenna connection structure of the disclosure, the electrical connector is between the panel antenna and the substrate. Besides, the electrical connector is capable of supporting them and electrically connects them. Compared to prior art, this simplifies the connection mechanism because it does not require utilizing each supporting stick and welding the wire.

### BRIEF DESCRIPTION OF THE DRAWINGS

The disclosure will become more fully understood from the detailed description and the drawings given herein below for illustration only, and thus does not limit the present disclosure, wherein:

FIG. 1 is an exploded view of an antenna connection structure according to an embodiment of the disclosure;

FIG. 2 is a perspective view of the antenna connection structure according to the embodiment of the disclosure;

FIG. 3 is a perspective view of an electrical connector of the antenna connection structure according to the embodiment of the disclosure;

FIG. 4 is another perspective view of the electrical connector of the antenna connection structure according to the embodiment of the disclosure;

FIG. 5 is a perspective view of the assembly of the electrical connector of the antenna connection structure according to the embodiment of the disclosure; and

FIG. 6 is a sectional view of the antenna connection structure according to the embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

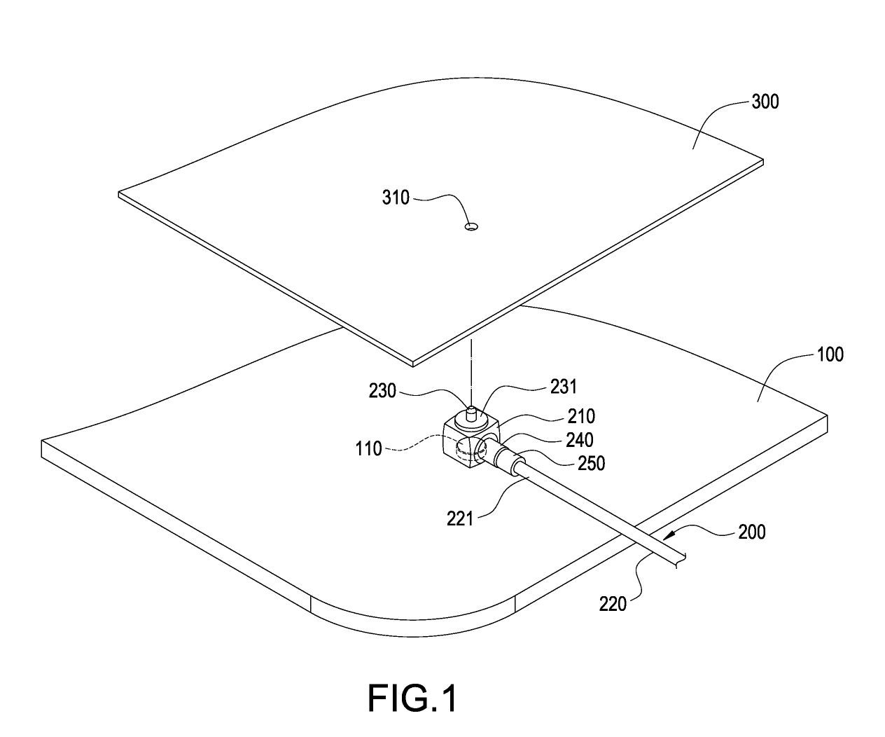

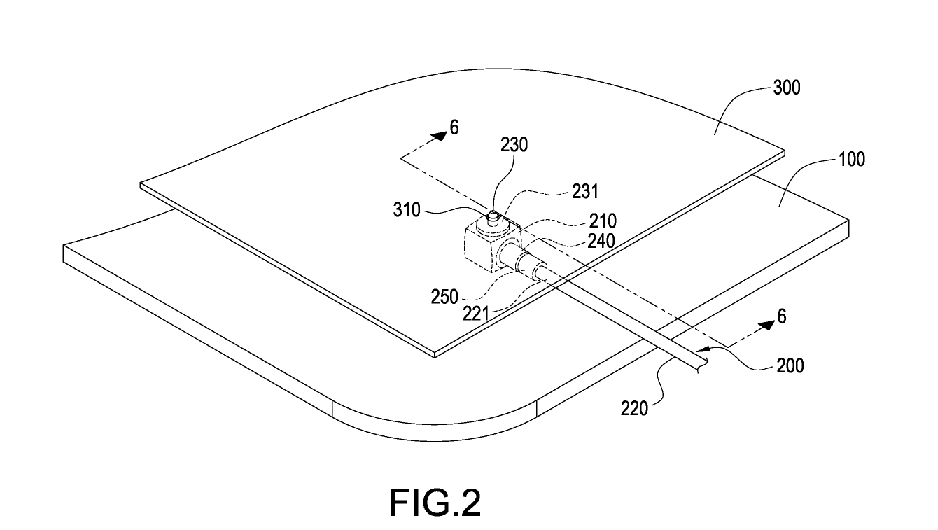

As shown in FIG. 1 and FIG. 2, an antenna connection structure of an embodiment of the disclosure comprises a substrate 100, at least one electrical connector 200 and a panel antenna 300.

The substrate 100 is preferably to be a circuit board and a circuit is arranged on the circuit board (not shown in the figures).

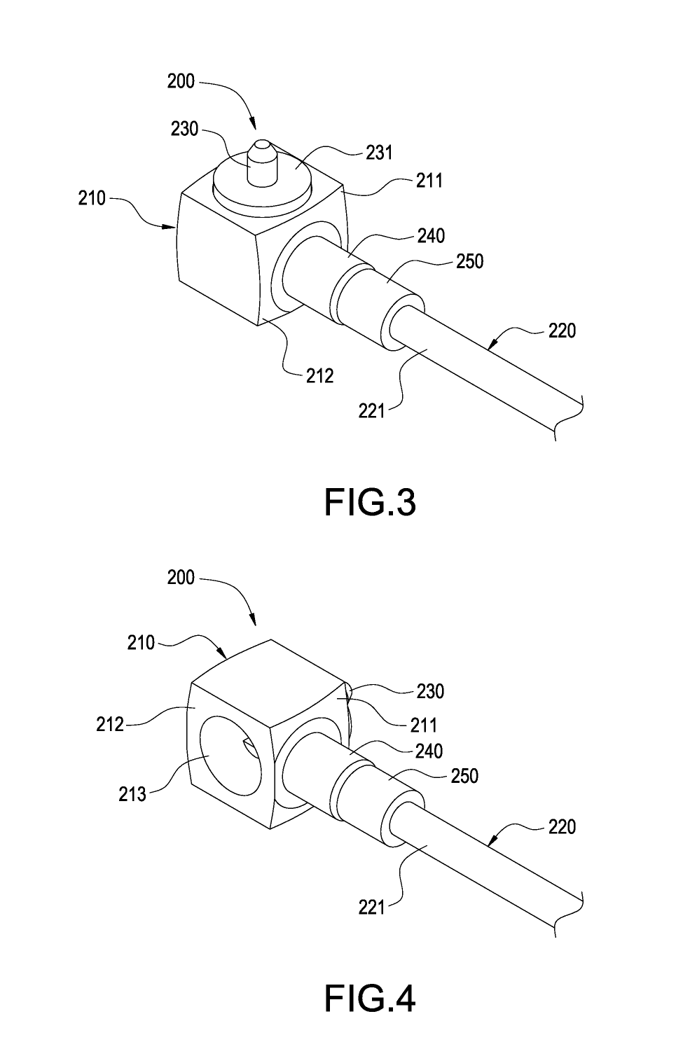

Referring to FIG. 3 and FIG. 4, the number of the electrical connectors 200 may be one or multiple while the structure and the arrangement of each electrical connector 200 are identical. Therefore, only one electrical connector 200 will be illustrated in this embodiment. The electrical connector 200 comprises a hollow cylinder 210 made of metal and a wire 220. Two ends of the hollow cylinder 210 are a top end 211 and a bottom end 212 respectively. The lateral side of the hollow cylinder 210 extends and forms a wiring tube 240 connecting the inner space of the hollow cylinder 210. An opening 214 is formed on the top end 211 of the hollow cylinder 210 while a connecting port 213 is formed on the bottom end 212. In this embodiment, two ends of the hollow cylinder 210 are connected, but the disclosure is not limited thereto. In other embodiments, the connecting port 213 may be a blind hole which does not connect the inner space of the hollow cylinder 210.

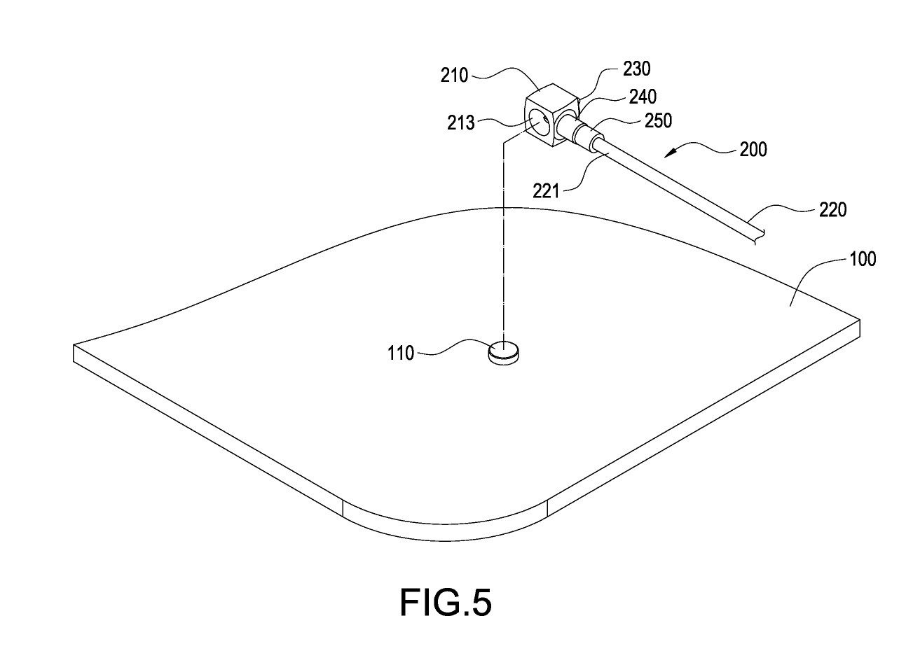

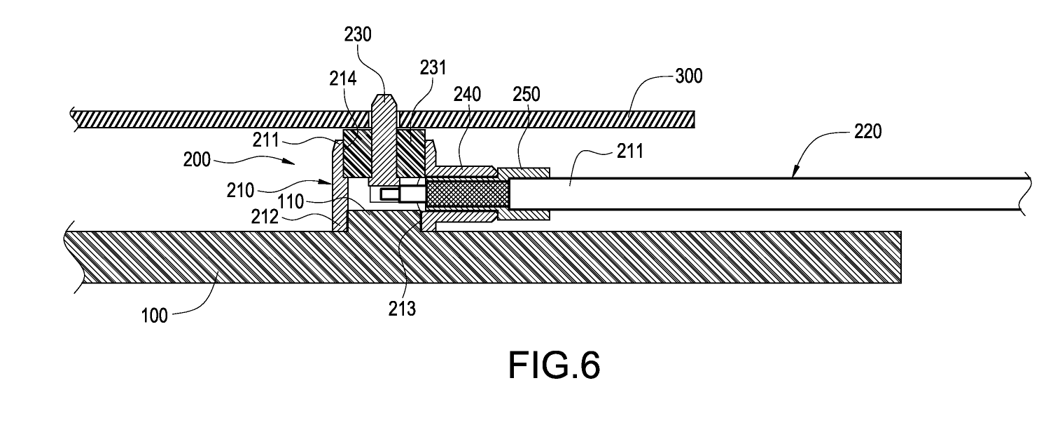

As seen in FIG. 5 and FIG. 6, a protruding block 110 corresponding to each connecting port 213 is disposed on a surface of the substrate 100. The connecting port 213 is sleeved on the protruding block 110 so that the bottom end 212 of the hollow cylinder 210 is connected to the substrate 100.

Referring to FIG. 3 and FIG. 4, a terminal 230 is disposed on the top end 211 of the hollow cylinder 210. The terminal 230 is disposed in and penetrates the hollow cylinder 210 while it protrudes from the top end 211 of the hollow cylinder 210. In this embodiment, the terminal 230 is plugged into and penetrates an insulating block 213 which is fixed to the inside of the opening 214, thereby making the terminal 230 be arranged along the axial direction of the hollow cylinder 210. The two ends of the wire 220 are connected to the substrate 100 and the panel antenna 300 respectively for electrically connecting the substrate 100 and the panel antenna 300. In this embodiment, the two ends of the wire 220 are preferably to be an antenna end and a substrate end respectively (not shown in the figures). An insulating sleeve 250 is sleeved on the outer side of the antenna end of the wire 220 and is disposed in the wiring tube 240 for avoiding the wire 220 electrically connecting the wiring tube 240. Thereby, the antenna end of the wire 220 goes into the hollow cylinder 210 through the wiring tube 240 and is electrically connected to the terminal 230. The substrate end of the wire 200 is connected to the substrate 100, wherein it can be fastened with or welded on the substrate 100 and be electrically connected to the circuit on the substrate, but the disclosure is not limited thereto.

Referring to FIG. 1, FIG. 2 and FIG. 6, a hole 310 is formed on the panel antenna 300. The top end 211 of the hollow cylinder 210 is in contact with the surface of the panel antenna 300 and is between and supports the panel antenna 300 and the substrate 100. Thus, the panel antenna 300 and the substrate 100 are separated from each other and are parallel to each other. The terminal 230 is plugged into the hole 310 and is electrically connected to the panel antenna 300 such that the panel antenna 300 and the substrate 100 are electrically connected via the electrical connector 200 and the wire 220.

In the antenna connection structure of the disclosure, the panel antenna 300 and the substrate 100 are electrically connected via the electrical connector 200, while the panel antenna 300 and the substrate 100 are parallel to each other because the hollow cylinder 210 of the electrical connector 200 is between and supports the panel antenna 300 and the substrate 100. As a result, this simplifies the connection mechanism of the panel antenna 300 and the substrate 100 because it does not require utilizing each supporting stick and welding the wire 220.

What is claimed is:

1. An antenna connection structure, comprising:
a substrate;
an electrical connector comprising a hollow cylinder and a wire, wherein two ends of the hollow cylinder are a top end and a bottom end respectively, the bottom end is connected to the substrate, a terminal is disposed on the top end and is arranged along an axial direction of the hollow cylinder, a end portion of the wire goes through the hollow cylinder via the lateral side thereof and is electrically connected to the terminal; and
a panel antenna with a hole formed thereon, wherein the hollow cylinder supports and is between the panel antenna and the substrate so that the panel antenna and the substrate are separated from each other and are parallel to each other, and the terminal is plugged into the hole.

2. The antenna connection structure according to claim 1, wherein the lateral side of the hollow cylinder extends and forms a wiring tube connecting the hollow cylinder, and the wire penetrates the hollow cylinder through the wiring tube.

3. The antenna connection structure according to claim 2, further comprising an insulating sleeve sleeved on the end portion of the wire and penetrating the wiring tube.

4. The antenna connection structure according to claim 1, wherein the top end of the hollow cylinder has an opening connecting an inner space of the hollow cylinder, and the terminal is disposed on and penetrates an insulating block disposed in the opening.

5. The antenna connection structure according to claim 1, wherein the bottom end of the hollow cylinder has a connection port, a protruding block is disposed on a surface of the substrate while the connection port is sleeved on the protruding block.

6. The antenna connection structure according to claim 5, wherein the connection port connecting an inner space of the hollow cylinder.

7. The antenna connection structure according to claim 1, wherein another end portion of the wire is connected to the substrate.

8. The antenna connection structure according to claim 1, wherein a circuit is disposed on the substrate while another end portion of the wire is connected to the substrate and is electrically connected to the circuit.
